(19) United States
(12) Patent Application Publication
(10) Pub. No.: US 2011/0071220 A1
(43) Pub. Date: Mar. 24, 2011

(54) Use of Tetronic Acid Derivatives for Fighting Insects and Red Spider Mites by Watering on the Ground, Droplet Application or Immersion Application

(75) Inventors: Heike Hungenberg, Langenfeld (DE); Peter Baur, Schondorf (DE); Ralf Nauen, Langenfeld (DE); Reiner Fischer, Monheim (DE); Udo Reckmann, Koln (DE); Wolfgang Thielert, Odenthal (DE)

(73) Assignee: Bayer CropScience AG, Monheim (DE)

(21) Appl. No.: 12/934,466

(22) PCT Filed: Mar. 27, 2008
(86) PCT No.: PCT/EP2008/002393

§ 371 Date: Dec. 7, 2010

(51) Int. Cl. A01N 43/12; A01P 7/04; A01P 7/00

(52) U.S. Cl. 514/462

(57) ABSTRACT

Compounds of the formula (II)

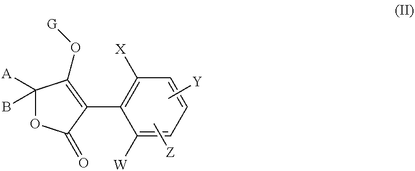

in which A, B, G, W, X, Y and Z may have the meanings given in the description are highly suitable for controlling animal pests such as insects and/or spider mites by treating the soil/growth substrate by watering or droplet application or dip application.

In soil applications, the activity of crop protection compositions comprising active compounds of the formula (II) can be improved by adjuvants. The present invention describes corresponding processes and suitable compositions.

The present invention relates to the use of tetronic acid derivatives for controlling insects and/or spider mites by watering, droplet application or dip (immersion) application.

It is known that certain substituted Δ³-dihydrofuran-2-one derivatives have herbicidal properties (cf. DE-A-4 014 420). The synthesis of the tetronic acid derivatives (such as, for example, 3-(2-methylphenyl)-4-hydroxy-5-(4-fluorophenyl)-Δ³-dihydrofuran-2-one) which are used as starting compounds, has also been described in DE-A-4 014 420. Compounds of a similar structure are known from the publication Campbell et al., J. Chem. Soc., Perkin Trans. 1, 1985, (8) 1567-76 without any insecticidal and/or acaricidal activity being mentioned. 3-Aryl-Δ³-dihydrofuranone derivatives having herbicidal, acaricidal and insecticidal properties are furthermore known from EP-A-528 156, EP-A-0 647 637, WO 95/26 345, WO 96/20 196, WO 96/25 395, WO 96/35 664, WO 97/01 535, WO 97/02 243, WO 97/36 868, WO 98/05638, WO 98/25928, WO 99/16748, WO 99/43649, WO 99/48869, WO 99/55673, WO 00/42850, WO 01/17972, WO 01/23354, WO 01/74770, WO 03/013 249, WO 04/024 688, WO 04/080 962, WO 04/111 042, WO 05/092897, WO 06/000355, WO 06/029799, WO 06/089633, WO 07/048,545 and WO 07/073,856.

Surprisingly, it has now been found that the tetronic acid derivatives are also highly suitable for controlling insects and spider mites by watering on the ground (known as “drenching” by persons skilled in the art), droplet application on the ground (known as “drip application” by persons skilled in the art) or dip application.

Accordingly, the present invention relates to the use of tetronic acid derivatives for controlling insects and/or spider mites by drenching, in irrigation systems as drip application or by dip application. The present invention relates in particular to these application forms on artificial soilless cultivation substrates (for example rock wool, glass wool, quartz sand, gravel, expanded clay, vermiculite), outdoors or in closed systems (for example greenhouses or under cloches) and in annual (for example vegetables, spices, ornamental plants), but also perennial (for example citrus plants, conifers, ornamental plants, shrubs) crops.

The present invention furthermore relates to the improvement of the action of agrochemical compositions in soil applications, to the agrochemical compositions suitable for this application and to their use for controlling harmful insects and/or spider mites.

Agrochemically active compounds can be applied by various means for controlling harmful organisms. In addition to foliar treatment, it is also possible to treat the cultivation substrate. This may be soil, and also specific substrates based inter alia on peat mosses, coconut fibers, rock wool, such as, for example Grodan®, pumice, expanded clay, such as, for example, Lecaton® or Lecadan®, clay granules, such as, for example, Seramis®, expanded plastic, such as, for example, Baystrat®), vermiculite, perlite, artificial soil, such as, for example, Hygromull®, or combinations of these substrates. Hereinbelow, all these cultivation substrates are referred to as soil. Application of active compounds into or onto the soil both brings harmful organisms living in the soil into contact with the active compound and initiates the uptake of systemically active compounds by the roots. Various auxiliaries for improving the action of agrochemically active compounds in foliar treatment are already known. These include, for example, penetrants which facilitate the penetration of the active compounds into the plant (for example WO 03/000053). Corresponding adjuvants for soil applications of insecticides and fungicides have not yet been described. The effect of soil penetration aids, which accelerate the penetration of irrigation water into dry soils (for example Agri-Prep® CS from Northwest Agricultural Products), are known.

It is also known that the surfactants can have an effect on the distribution of permethrin in the soil (Howell, McMullan P. M. (ed.), 1998, Adjuvants for Agrochemicals, Proceedings of the 5th international Symposium on Adjuvants for Agrochemicals, Memphis, USA, pp. 247-253).

The improvement of herbicidal compositions by optimized formulations has also been described (Chung et al., Pesticide Science, 1993, 38 (2-3), pp. 250-252).

Surprisingly, it has now been found that the biological activity of insecticidal and/or acaricidal compositions in soil applications can be improved by adding an adjuvant to these compositions. Here, the adjuvant can either be a component of the concentrated formulation (in-can formulation) or be added during the preparation of the ready-to-use pesticide solution (tank-mix application). The improved activity manifests itself in particular in the control of foliar pests which are controlled by a systemic action of the active compounds. In this manner, the compositions according to the invention allow the active compound application rate to be reduced or improved action to be achieved at the same application rate. In addition, the consumption of water can be minimized.

Accordingly, the present invention also provides the use of adjuvants for improving the activity of agrochemical compositions in soil applications, for example by spraying onto the soil, watering, side-dressing, shower-drenching, overhead-drenching, dip application or application in connection with an irrigation system (drip irrigation).

We have now found novel suspension concentrates for this use, comprising
at least one agrochemically active compound, solid at room temperature, from the group of the insecticides and/or acaricides of the formula (II),
at least one adjuvant,

In addition to concentrated formulations, the invention also provides dilute ready-to-use compositions. The invention furthermore provides the use of these compositions for controlling foliar pests.

Examples of adjuvants according to the invention which may be mentioned are in particular the following substances and compositions:
(I-1) dioctyl sodium sulfosuccinate, commercially available, for example, in the product series Geropon®,
(I-2) compositions comprising dioctyl sodium sulfosuccinate and sodium benzoate, commercially available, for example, in the product series Aerosol®; the dioctyl sodium sulfosuccinate:sodium benzoate weight ratio is preferably from 5:1 to 6:1,
(I-3) terminally capped alkoxylated fatty alcohols and terminally capped alkoxylated straight-chain alcohols, commercially available, for example, in the product series Plurafac®; preference is given to ethoxylated and/or butoxylated fatty alcohols and terminally capped ethoxylated and/or butoxylated straight-chain alcohols,
(I-4) tributylphenol polyglycol ethers having 10 to 15 EO units (where EO is ethylene oxide), commercially available, for example, in the product series Sapogenat®,
(I-5) polyalkylene oxide-modified polymethylsiloxanes, commercially available, for example, in the product series Silwet®,
(I-6) branched alkanol alkoxylates of the formula CH₃—(CH₂)ₜ—CH₂—O—(—CH₂—CH₂—O—)ᵤ—H, in which t represents numbers from 9 to 10.5 and u represents numbers from 6 to 25 (preferably from 8 to 12) and t and u are average values, commercially available, for example, in the product series Lutensol®,
(I-7) betaine
(I-8) polyalkoxylated triglycerides, where the triglyceride is preferably of vegetable origin, commercially available, for example, in the product series Crovol®,
(I-9) alkoxylated fatty amines, commercially available, for example, in the product series Armoblen®,
(I-10) sodium laureth sulfate, commercially available, for example, in the product series Genapol®,
(I-11) PEG-10 coconut alcohol, commercially available, for example, in the product series Genapol®,
(I-12) compositions comprising corn syrup, petroleum oil and nonionic emulsifier, commercially available, for example, in the product series Superb®.

The advantageous effect of these adjuvants is given in principle for the insecticides and/or acaricides from the classes of the tetronic acid derivatives.

The insecticidally and/or acaricidally utilizable tetronic acid derivatives according to the invention are known from the applications cited at the outset and are defined by the general formula (II)

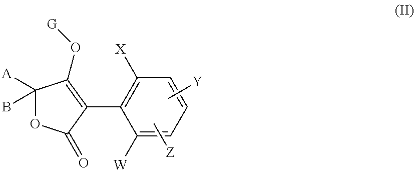

in which
W represents hydrogen, alkyl, alkenyl, alkynyl, halogen, alkoxy, haloalkyl, haloalkoxy or cyano,
X represents halogen, alkyl, alkenyl, alkynyl, alkoxy, alkoxyalkoxy, haloalkyl, haloalkoxy or cyano,
Y represents hydrogen, halogen, alkyl, alkenyl, alkynyl, alkoxy, cyano, haloalkyl, haloalkoxy or represents in each case optionally substituted phenyl or hetaryl,
Z represents hydrogen, halogen, alkyl, haloalkyl, cyano, alkoxy or haloalkoxy,
A represents hydrogen, in each case optionally halogen-substituted alkyl, alkenyl, alkoxyalkyl, alkylthioalkyl, saturated or unsaturated, optionally substituted cycloalkyl,
B represents hydrogen, alkyl or alkoxyalkyl, or
A and B together with the carbon atom to which they are attached represent a saturated or unsaturated, unsubstituted or substituted cycle which optionally contains at least one heteroatom,
G represents hydrogen (a) or one of the groups

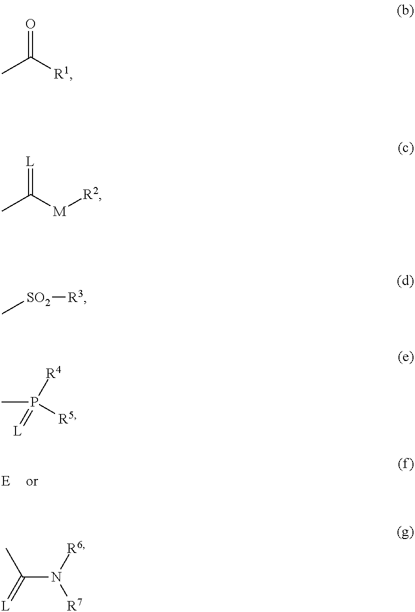

in which
E represents a metal ion equivalent or an ammonium ion,
L represents oxygen or sulfur,
M represents oxygen or sulfur,
R¹ represents in each case optionally halogen-substituted alkyl, alkenyl, alkoxyalkyl, alkylthioalkyl, polyalkoxyalkyl or optionally halogen-, alkyl- or alkoxy-substituted cycloalkyl which may be interrupted by at least one heteroatom, represents in each case optionally substituted phenyl, phenylalkyl, hetaryl, phenoxyalkyl or hetaryloxyalkyl,
R² represents in each case optionally halogen-substituted alkyl, alkenyl, alkoxyalkyl, polyalkoxyalkyl or represents in each case optionally substituted cycloalkyl, phenyl or benzyl,
R³, R⁴ and R⁵ independently of one another represent in each case optionally halogen-substituted alkyl, alkoxy, alkylamino, dialkylamino, alkylthio, alkenylthio or cycloalkylthio or represent in each case optionally substituted phenyl, benzyl, phenoxy or phenylthio,
R⁶ and R⁷ independently of one another represent hydrogen, in each case optionally halogen-substituted alkyl, cycloalkyl, alkenyl, alkoxy, alkoxyalkyl, optionally substituted phenyl, optionally substituted benzyl, or together with the N atom to which they are bonded represent a cycle which is optionally interrupted by oxygen or sulfur.

Particular preference is given to compounds of the formula (II) in which
W particularly preferably represents hydrogen, methyl, ethyl, chlorine, bromine or methoxy,
X particularly preferably represents chlorine, bromine, methyl, ethyl, propyl, i-propyl, methoxy, ethoxy or trifluoromethyl,
Y and Z particularly preferably independently of one another represent hydrogen, fluorine, chlorine, bromine, methyl, ethyl, propyl, i-propyl, trifluoromethyl or methoxy,
A particularly preferably represents methyl, ethyl, propyl, i-propyl, butyl, i-butyl, sec-butyl, tert-butyl, cyclopropyl, cyclopentyl or cyclohexyl,
B particularly preferably represents hydrogen, methyl or ethyl,
A, B and the carbon atom to which they are attached particularly preferably represent saturated C₅-C₆-cycloalkyl in which optionally one ring member is replaced by oxygen and which is optionally monosubstituted by methyl, ethyl, methoxy, ethoxy, propoxy or butoxy,
G particularly preferably represents hydrogen (a) or represents one of the groups

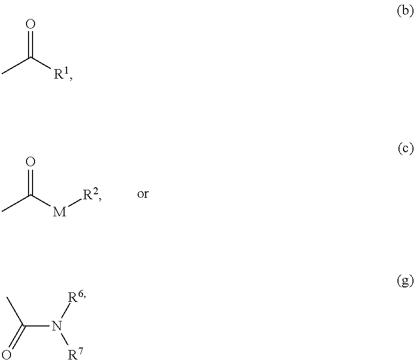

in which
M represents oxygen or sulfur,
R¹ particularly preferably represents C₁-C₈-alkyl, C₂-C₄-alkenyl, methoxymethyl, ethoxymethyl, ethylthiomethyl, cyclopropyl, cyclopentyl or cyclohexyl,
   represents optionally fluorine-, chlorine-, bromine-, cyano-, nitro-, methyl-, ethyl-, methoxy-, trifluoromethyl- or trifluoromethoxy-substituted phenyl,
   represents in each case optionally chlorine- or methyl-substituted pyridyl or thienyl,
R² particularly preferably represents C₁-C₈-alkyl, C₂₋C₄-alkenyl, methoxyethyl, ethoxyethyl or represents phenyl or benzyl,
R⁶ and R⁷ independently of one another particularly preferably represent methyl, ethyl or together represent a C₅-alkylene radical in which the C₃-methylene group is replaced by oxygen.

Very particular preference is given to compounds of the formula (II) in which
W very particularly preferably represents hydrogen or methyl,
X very particularly preferably represents chlorine, bromine or methyl,
Y and Z very particularly preferably independently of one another represent hydrogen, chlorine, bromine or methyl,
A, B and the carbon atom to which they are attached very particularly preferably represent saturated C₅-C₆-cycloalkyl in which optionally one ring member is replaced by oxygen and which is optionally monosubstituted by methyl, trifluoromethyl, methoxy, ethoxy, propoxy or butoxy,
G very particularly preferably represents hydrogen (a) or represents one of the groups

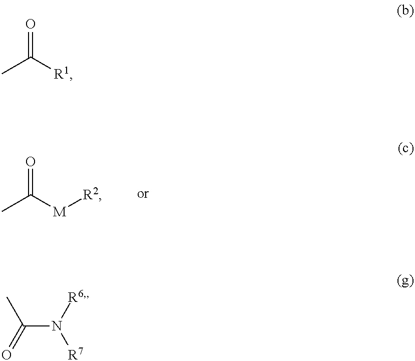

in which
M represents oxygen or sulfur,
R¹ very particularly preferably represents C₁-C₈-alkyl, C₂-C₄-alkenyl, methoxymethyl, ethoxymethyl, ethylthiomethyl, cyclopropyl, cyclopentyl, cyclohexyl or
   represents phenyl which is optionally monosubstituted by fluorine, chlorine, bromine, methyl, methoxy, trifluoromethyl, trifluoromethoxy, cyano or nitro,
   represents in each case optionally chlorine- or methyl-substituted pyridyl or thienyl,
R² very particularly preferably represents C₁-C₈-alkyl, C₂-C₄-alkenyl, methoxyethyl, ethoxyethyl, phenyl or benzyl,
R⁶ and R⁷ independently of one another very particularly preferably represent methyl, ethyl or together represent a C₅-alkylene radical in which the C₃-methylene group is replaced by oxygen.

Depending on the nature of the substitution, the compounds of the formula (II) may also be present as optical isomers or isomer mixtures of varying compositions.

Especially preferred are compounds of the formulae (II-1) spirodiclofen and (II-2) spiromesifen:

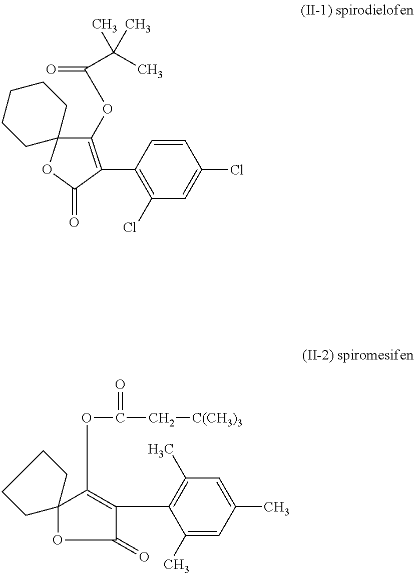

In addition to at least one active compound and at least one adjuvant, the compositions according to the invention may furthermore preferably comprise further formulation auxiliaries:
at least one nonionic surfactant and/or at least one anionic surfactant and
one or more additives from the groups of the antifreeze agents, the antifoams, the preservatives, the antioxidants, the spreading agents, the colorants and/or the thickeners.

Examples of further ingredients of the formulations according to the invention which may be mentioned are, in particular, the following substances:

Suitable nonionic surfactants are all compounds of this type which are usually employed in agrochemical compositions. Polyethylene oxide/polypropylene oxide block copolymers, polyethylene glycol ethers of straight-chain alcohols, reaction products of fatty acids with ethylene oxide and/or propylene oxide, furthermore polyvinyl alcohol, polyvinylpyrrolidone, mixed polymers of polyvinyl alcohol and polyvinylpyrrolidone, mixed polymers of polyvinyl acetate and polyvinylpyrrolidone and also copolymers of (meth)acrylic acid and (meth)acrylic esters, furthermore alkyl ethoxylates and alkylaryl ethoxylates which may optionally be phosphated and may optionally be neutralized with bases, polyoxyamine derivatives and nonylphenol ethoxylates may be mentioned as being preferred.

Suitable anionic surfactants include all substances of this type that can typically be used in agrochemical compositions. Preference is given to alkali metal salts and alkaline earth metal salts of alkylsulfonic acids or alkylarylsulfonic acids.

A further preferred group of anionic surfactants and/or dispersants are salts of polystyrenesulfonic acids, salts of polyvinylsulfonic acids, salts of naphthalenesulfonic acid-formaldehyde condensation products, salts of condensation products of naphthalenesulfonic acid, phenolsulfonic acid and formaldehyde, and salts of lignosulfonic acid.

Suitable antifreeze agents are all substances of this type which are usually employed in agrochemical compositions. Preference is given to urea, glycerol, polyglycerol and polyglycerol derivatives, propanediol and propylene glycol.

Suitable antifoams are all substances usually employed for this purpose in agrochemical compositions. Preference is given to silicone oils and magnesium stearate.

Suitable preservatives are all substances usually employed for this purpose in agrochemical compositions of this type. Examples which may be mentioned are Preventol® (from Bayer AG) and Proxel®.

Suitable antioxidants are all substances which are usually employed for this purpose in agrochemical compositions. Examples which may be mentioned are: propyl gallate, octyl gallate, dodecyl gallate, butylated hydroxyanisole, propyl paraben, sodium benzoate, nordihydroguaiaretic acid and butylated hydroxytoluene. Preference is given to butylated hydroxytoluene (2,6-di-t-butyl-4-methylphenol, BHT).

Suitable spreaders are all substances which are usually employed for this purpose in agrochemical compositions. Preference is given to polyether- or organo-modified polysiloxanes.

Suitable colorants are all substances which are usually employed for this purpose in agrochemical compositions. Examples which may be mentioned are titanium dioxide, pigment-grade carbon black, zinc oxide and blue pigments and also permanent red FGR.

Suitable thickeners are all substances of this type which are usually employed in agrochemical compositions. Preference is given to silicates (such as, for example, Atagel® 50 from Engelhard) or xanthan gum (such as, for example, Kelzan® S from Kelko).

The concentrated formulations according to the invention are prepared by mixing the components with one another in the particular ratios desired. The components may be mixed with one another in any order. Expediently, the solid components are employed in a finely ground state. However, it is also possible to subject the suspension formed after mixing of the components initially to a coarse grinding and then to a fine grinding so that the mean particle size is below 20 μm. Preferred are suspension concentrates in which the solid particles have a mean particle size of from 1 to 10 μm.

When carrying out the process according to the invention, the temperatures may be varied within a certain range. In general, the process is carried out at temperatures between 10° C. and 60° C., preferably between 15° C. and 40° C.

Suitable for carrying out the process according to the invention are customary mixers and grinders employed for producing agrochemical formulations.

The compositions according to the invention are formulations which are stable even after prolonged storage at elevated temperatures or in the cold, since no crystal growth is observed. By dilution with water, they can be converted into homogeneous spray liquors.

The application rate of the compositions according to the invention can be varied within a relatively wide range. It depends on the agrochemically active compounds in question and their content in the compositions.

Compositions according to the invention comprise
at least one tetronic acid derivative of the formula (II) and
at least one adjuvant.

In a particularly preferred embodiment, compositions according to the invention comprise:
at least one active compound of the general formula (II) and
at least one substance or composition selected from the group consisting of (I-1) to (I-12)

In a very particularly preferred embodiment, compositions according to the invention comprise:
at least one active compound selected from tetronic acid derivatives of the formulae (II-1) and (II-2) and
at least one substance or composition selected from the group consisting of (I-1) to (I-12)

The compositions according to the invention comprise—if they are concentrated formulations
generally from 1 to 60% by weight of one or more agrochemically active compounds of the formula (II) which may be used according to the invention, preferably from 5 to 50% by weight and particularly preferably from 10 to 30% by weight,
generally from 1 to 50% by weight of at least one adjuvant according to the invention, preferably from 2 to 30% by weight and particularly preferably from 5 to 20% by weight,
generally from 1 to 20% by weight of nonionic surfactants and/or anionic surfactants, preferably from 2.5 to 10% by weight,
generally from 1 to 20% by weight of antifreeze agent, preferably from 5 to 15% by weight,
generally from 0.1 to 20% by weight of additives, preferably from 0.1 to 15% by weight.

The compositions according to the invention comprise—if they are ready-to-use formulations (solutions for watering) —generally from 0.05 to 10 g/l of adjuvant, preferably from 0.1 to 8 g/l and particularly preferably from 0.1 to 5 g/l.

Very particularly preferred concentrated formulations for soil applications comprise
from 1 to 60% by weight of at least one active compound of the general formula (II),
from 1 to 50% by weight of at least one substance or composition selected from the group consisting of (I-1) to (I-12),
from 1 to 20% by weight of at least one nonionic surfactant and/or anionic surfactant,
from 1 to 20% by weight of antifreeze agent and
from 0.1 to 20% by weight of additives from the groups of the antifoams, the preservatives, the antioxidants, the spreading agents, the colorants and/or the thickeners.

Especially preferred concentrated formulations for soil applications comprise
from 1 to 60% by weight of at least one active compound selected from the group consisting of (II-1) and (II-2),
from 1 to 50% by weight of at least one substance or composition selected from the group consisting of (I-1) to (I-12),
from 1 to 20% by weight of at least one nonionic surfactant and/or anionic surfactant,
from 1 to 20% by weight of antifreeze agent,
from 0.1 to 20% by weight of additives from the groups of the antifoams, the preservatives, the antioxidants, the spreading agents, the colorants and/or the thickeners.

In general, preference is given to certain combinations of active compounds and adjuvants listed in the table below, where each combination listed is preferred per se:

| | Active | |
|---|---|---|
| # | compound | Adjuvant |
| 1 | (II-1) | Dioctyl sodium sulfosuccinate |
| 2 | (II-1) | Compositions comprising dioctyl sodium sulfosuccinate and sodium benzoate |
| 3 | (II-1) | Terminally capped alkoxylated fatty alcohols and terminally capped |
| | | alkoxylated straight-chain alcohols |
| 4 | (II-1) | Tributylphenol polyglycol ethers having 10 to 15 EO units |
| 5 | (II-1) | Polyalkylene oxide-modified polymethylsiloxanes |
| 6 | (II-1) | Branched alkanol alkoxylates of the formula |
| | | CH₃—(CH₂)ₜ—CH₂—O—(—CH₂—CH₂—O—)ᵤ—H, in which t represents numbers from |
| | | 9 to 10.5 and u represents numbers from 6 to 25 |
| 7 | (II-1) | Betaine |
| 8 | (II-1) | Polyalkoxylated triglycerides |
| 9 | (II-1) | Alkoxylated fatty amines |
| 10 | (II-1) | Sodium laureth sulfate |
| 11 | (II-1) | PEG-10 coconut alcohol |
| 12 | (II-1) | Compositions comprising corn syrup, petroleum oil and nonionic emulsifier |
| 13 | (II-2) | Dioctyl sodium sulfosuccinate |
| 14 | (II-2) | Compositions comprising dioctyl sodium sulfosuccinate and sodium benzoate |
| 15 | (II-2) | Terminally capped alkoxylated fatty alcohols and terminally capped |
| | | alkoxylated straight-chain alcohols |
| 16 | (II-2) | Tributylphenol polyglycol ethers having 10 to 15 EO units |
| 17 | (II-2) | Polyalkylene oxide-modified polymethylsiloxanes |
| 18 | (II-2) | Branched alkanol alkoxylates of the formula |
| | | CH₃—(CH₂)ₜ—CH₂—O—(—CH₂—CH₂—O—)ᵤ—H, in which t represents numbers from |
| | | 9 to 10.5 and u represents numbers from 6 to 25 |
| 19 | (II-2) | Betaine |
| 20 | (II-2) | Polyalkoxylated triglycerides |
| 21 | (II-2) | Alkoxylated fatty amines |
| 22 | (II-2) | Sodium laureth sulfate |
| 23 | (II-2) | PEG-10 coconut alcohol |
| 24 | (II-2) | Compositions comprising corn syrup, petroleum oil and nonionic emulsifier |

Very particular preference is also given to ready-to-use compositions for soil applications which are obtained by diluting the concentrated solutions mentioned above.

The crops to be protected which have only been described in general terms will be described in greater detail and specified hereinbelow. Thus, as regards the use, vegetables are understood as meaning for example fruiting vegetables and inflorescences as vegetables, for example bell peppers, chilies, tomatoes, aubergines, cucumbers, pumpkins, courgettes, broad beans, runner beans, dwarf beans, peas, artichokes, corn;

but also leafy vegetables, for example head-forming lettuce, chicory, endives, various types of cress, of rocket, lamb's lettuce, iceberg lettuce, leeks, spinach, Swiss chard;

furthermore tuber vegetables, root vegetables and stem vegetables, for example celeriac/celery, beetroot, carrots, radish, horseradish, scorzonera, asparagus, beet for human consumption, palm hearts, bamboo shoots, furthermore bulb vegetables, for example onions, leeks, fennel, garlic;

furthermore Brassica vegetables such as cauliflower, broccoli, kohlrabi, red cabbage, white cabbage, curly kale, Savoy cabbage, Brussel sprouts, Chinese cabbage.

Regarding the use, perennial crops are understood as meaning citrus, such as, for example, oranges, grapefruits, tangerines, lemons, limes, Seville oranges, kumquats, satsumas;

but also pome fruit such as, for example, apples, pears and quinces, and stone fruit, such as, for example, peaches, nectarines, cherries, plums, quetsch, apricots;

furthermore grapevines, hops, olives, tea and tropical crops such as, for example, mangoes, papayas, figs, pineapples, dates, bananas, durians, kaki fruit, coconuts, cacao, coffee, avocados, lychees, maracujas, guavas,

moreover almonds and nuts such as, for example, hazelnuts, walnuts, pistachios, cashew nuts, para nuts, pecan nuts, butternuts, chestnuts, hickory nuts, macadamia nuts, peanuts,

moreover also soft fruit such as, for example, redcurrants, gooseberries, raspberries, blackberries, blueberries, strawberries, cranberries, including American cranberries, kiwi fruit.

As regards the use, ornamentals are understood as meaning annual and perennial plants, for example cut flowers such as, for example, roses, carnations, gerbera, lilies, marguerites, chrysanthemums, tulips, narcissi, anemones, poppies, amaryllis, dahlias, azaleas, hibiscus,

but also for example bedding plants, pot plants and perennials such as, for example, roses, Tagetes, violas, geraniums, fuchsias, hibiscus, chrysanthemums, busy lizzies, cyclamen, African violet, sunflowers, begonias,

furthermore for example bushes and conifers such as, for example, ficus, rhododendron, firs, spruces, pines, including umbrella pines, yews, juniper, oleander.

As regards the use, spices are understood as meaning annual and perennial plants such as, for example, aniseed, chili pepper, paprika, pepper, vanilla, marjoram, thyme, cloves, juniper berries, cinnamon, tarragon, coriander, saffron, ginger.

The insecticidal compositions according to the invention, in combination with good plant tolerance and favorable toxicity to warm-blooded animals and good environmental tolerance, are suitable for protecting plants and plant organs, for increasing the harvest yields, for improving the quality of the harvested material and for controlling animal pests, in particular insects, arachnids, helminths, nematodes and molluscs, which are encountered in agriculture, in horticulture, in forests and in gardens and leisure facilities. They may be preferably employed as plant protection agents. They are active against normally sensitive and resistant species and against all or some stages of development. The abovementioned pests include:

From the order of the Anoplura (Phthiraptera), for example, Damalinia spp., Haematopinus spp., Linognathus spp., Pediculus spp., Trichodectes spp.

From the class of the Arachnida, for example, Acarus siro, Aceria sheldoni, Aculops spp., Aculus spp., Amblyomma spp., Argas spp., Boophilus spp., Brevipalpus spp., Bryobia praetiosa, Chorioptes spp., Dermanyssus gallinae, Eotetranychus spp., Epitrimerus pyri, Eutetranychus spp., Eriophyes spp., Hemitarsonemus spp., Hyalomma spp., Ixodes spp., Latrodectus mactans, Metatetranychus spp., Oligonychus spp., Ornithodoros spp., Panonychus spp., Phyllocoptruta oleivora, Polyphagotarsonemus latus, Psoroptes spp., Rhipicephalus spp., Rhizoglyphus spp., Sarcoptes spp., Scorpio maurus, Stenotarsonemus spp., Tarsonemus spp., Tetranychus spp., Vasates lycopersici.

From the class of the Bivalva, for example, Dreissena spp.

From the order of the Chilopoda, for example, Geophilus spp., Scutigera spp.

From the order of the Coleoptera, for example, Acanthoscelides obtectus, Adoretus spp., Agelastica alni, Agriotes spp., Amphimallon solstitialis, Anobium punctatum, Anoplophora spp., Anthonomus spp., Anthrenus spp., Apogonia spp., Atomaria spp., Attagenus spp., Bruchidius obtectus, Bruchus spp., Ceuthorhynchus spp., Cleonus mendicus, Conoderus spp., Cosmopolites spp., Costelytra zealandica, Curculio spp., Cryptorhynchus lapathi, Dermestes spp., Diabrotica spp., Epilachna spp., Faustinus cubae, Gibbium psylloides, Heteronychus arator, Hylamorpha elegans, Hylotrupes bajulus, Hypera postica, Hypothenemus spp., Lachnosterna consanguinea, Leptinotarsa decemlineata, Lissorhoptrus oryzophilus, Lixus spp., Lyctus spp., Meligethes aeneus, Melolontha melolontha, Migdolus spp., Monochamus spp., Naupactus xanthographus, Niptus hololeucus, Oryctes rhinoceros, Oryzaephilus surinamensis, Otiorrhynchus sulcatus, Oxycetonia jucunda, Phaedon cochleariae, Phyllophaga spp., Popillia japonica, Premnotrypes spp., Psylliodes chrysocephala, Ptinus spp., Rhizobius ventralis, Rhizopertha dominica, Sitophilus spp., Sphenophorus spp., Stemechus spp., Symphyletes spp., Tenebrio molitor, Tribolium spp., Trogo-derma spp., Tychius spp., Xylotrechus spp., Zabrus spp.

From the order of the Collembola, for example, Onychiurus armatus.

From the order of the Dermaptera, for example, Forficula auricularia.

From the order of the Diplopoda, for example, Blaniulus guttulatus.

From the order of the Diptera, for example, Aedes spp., Anopheles spp., Bibio hortulanus, Calliphora erythrocephala, Ceratitis capitata, Chrysomyia spp., Cochliomyia spp., Cordylobia anthropophaga, Culex spp., Cuterebra spp., Dacus oleae, Dermatobia hominis, Drosophila spp., Fannia spp., Gastrophilus spp., Hylemyia spp., Hyppobosca spp., Hypoderma spp., Liriomyza spp. Lucilia spp., Musca spp., Nezara spp., Oestrus spp., Oscinella frit, Pegomyia hyoscyami, Phorbia spp., Stomoxys spp., Tabanus spp., Tannia spp., Tipula paludosa, Wohlfahrtia spp.

From the class of the Gastropoda, for example, Anion spp., Biomphalaria spp., Bulinus spp., Deroceras spp., Galba spp., Lymnaea spp., Oncomelania spp., Succinea spp.

From the class of the helminths, for example, Ancylostoma duodenale, Ancylostoma ceylanicum, Acylostoma braziliensis, Ancylostoma spp., Ascaris lubricoides, Ascaris spp., Brugia malayi, Brugia timori, Bunostomum spp., Chabertia spp., Clonorchis spp., Cooperia spp., Dicrocoelium spp, Dictyocaulus filaria, Diphyllobothrium latum, Dracunculus medinensis, Echinococcus granulosus, Echinococcus multilocularis, Enterobius veimicularis, Faciola spp., Haemonchus spp., Heterakis spp., Hymenolepis nana, Hyostrongulus spp., Loa Loa, Nematodirus spp., Oesophagostomum spp., Opisthorchis spp., Onchocerca volvulus, Ostertagia spp., Paragonimus spp., Schistosomen spp., Strongyloides fuelleborni, Strongyloides stercoralis, Stronyloides spp., Taenia saginata, Taenia solium, Trichinella spiralis, Trichinella nativa, Trichinella britovi, Trichinella nelsoni, Trichinella pseudopsiralis, Trichostrongulus spp., Trichuris trichuria, Wuchereria bancrofti.

It is furthermore possible to control Protozoa, such as Eimeria.

From the order of the Heteroptera, for example, Anasa tristis, Antestiopsis spp., Blissus spp., Calocoris spp., Campylomma livida, Cavelerius spp., Cimex spp., Creontiades dilutus, Dasynus piperis, Dichelops furcatus, Diconocoris hewetti, Dysdercus spp., Euschistus spp., Eurygaster spp., Heliopeltis spp., Horcias nobilellus, Leptocorisa spp., Leptoglossus phyllopus, Lygus spp., Macropes excavatus, Miridae, Nezara spp., Oebalus spp., Pentomidae, Piesma quadrata, Piezodorus spp., Psallus seriatus, Pseudacysta persea, Rhodnius spp., Sahlbergella singularis, Scotinophora spp., Stephanitis nashi, Tibraca spp., Triatoma spp.

From the order of the Homoptera, for example, Acyrthosipon spp., Aeneolamia spp., Agonoscena spp., Aleurodes spp., Aleurolobus barodensis, Aleurothrixus spp., Amrasca spp., Anuraphis cardui, Aonidiella spp., Aphanostigma pini, Aphis spp., Arboridia apicalis, Aspidiella spp., Aspidiotus spp., Atanus spp., Aulacorthum solani, Bemisia spp., Brachycaudus helichrysii, Brachycolus spp., Brevicoryne brassicae, Calligypona marginata, Carneocephala fulgida, Ceratovacuna lanigera, Cercopidae, Ceroplastes spp., Chaetosiphon fragaefolii, Chionaspis tegalensis, Chlorita onukii, Chromaphis juglandicola, Chrysomphalus ficus, Cicadulina mbila, Coccomytilus halli, Coccus spp., Cryptomyzus ribis, Dalbulus spp., Dialeurodes spp., Diaphorina spp., Diaspis spp., Doralis spp., Drosicha spp., Dysaphis spp., Dysmicoccus spp., Empoasca spp., Eriosoma spp., Erythroneura spp., Euscelis bilobatus, Geococcus coffeae, Homalodisca coagulata, Hyalopterus arundinis, Icerya spp., Idiocerus spp., Idioscopus spp., Laodelphax striatellus, Lecanium spp., Lepidosaphes spp., Lipaphis erysimi, Macrosiphum spp., Mahanarva fimbriolata, Melanaphis sacchari, Metcalfiella spp., Metopolophium dirhodum, Monellia costalis, Monelliopsis pecanis, Myzus spp., Nasonovia ribisnigri, Nephotettix spp., Nilaparvata lugens, Oncometopia spp., Orthezia praelonga, Parabemisia myricae, Paratrioza spp., Parlatoria spp., Pemphigus spp., Peregrinus maidis, Phenacoccus spp., Phloeomyzus passerinii, Phorodon humuli, Phylloxera spp., Pinnaspis aspidistrae, Planococcus spp., Protopulvinaria pyriformis, Pseudaulacaspis pentagona, Pseudococcus spp., Psylla spp., Pteromalus spp., Pyrilla spp., Quadraspidiotus spp., Quesada gigas, Rastrococcus spp., Rhopalosiphum spp., Saissetia spp., Scaphoides titanus, Schizaphis graminum, Selenaspidus articulatus, Sogata spp., Sogatella furcifera, Sogatodes spp., Stictocephala festina, Tenalaphara malayensis, Tinocallis caryaefoliae, Tomaspis spp., Toxoptera spp., Trialeurodes vaporariorum, Trioza spp., Typhlocyba spp., Unaspis spp., Viteus vitifolii.

From the order of the Hymenoptera, for example, Diprion spp., Hoplocampa spp., Lasius spp., Monomorium pharaonis and Vespa spp.

From the order of the Isopoda, for example, Armadillidium vulgare, Oniscus asellus and Porcellio scaber.

From the order of the Isoptera, for example, Reticulitermes spp. and Odontotermes spp.

From the order of the Lepidoptera, for example, Acronicta major, Aedia leucomelas, Agrotis spp., Alabama argillacea, Anticarsia spp., Barathra brassicae, Bucculatrix thurberiella, Bupalus piniarius, Cacoecia podana, Capua reticulana, Carpocapsa pomonella, Chematobia brumata, Chilo spp., Choristoneura fumiferana, Clysia ambiguella, Cnaphalocerus spp., Earias insulana, Ephestia kuehniella, Euproctis chrysorrhoea, Euxoa spp., Feltia spp., Galleria mellonella, Helicoverpa spp., Heliothis spp., Hofmannophila pseudospretella, Homona magnanima, Hyponomeuta padella, Laphygma spp., Lithocolletis blancardella, Lithophane antennata, Loxagrotis albicosta, Lymantria spp., Malacosoma neustria, Mamestra brassicae, Mocis repanda, Mythimna separata, Oria spp., Oulema oryzae, Panolis flammea, Pectinophora gossypiella, Phyllocnistis citrella, Pieris spp., Plutella xylostella, Prodenia spp., Pseudaletia spp., Pseudoplusia includens, Pyrausta nubilalis, Spodoptera spp., Thermesia gemmatalis, Tinea pellionella, Tineola bisselliella, Tortrix viridana, Trichoplusia spp.

From the order of the Orthoptera, for example, Acheta domesticus, Blatta orientalis, Blattella germanica, Gryllotalpa spp., Leucophaea maderae, Locusta spp., Melanoplus spp., Periplaneta americana, Schistocerca gregaria.

From the order of the Siphonaptera, for example, Ceratophyllus spp. and Xenopsylla cheopis.

From the order of the Symphyla, for example, Scutigerella immaculata.

From the order of the Thysanoptera, for example, Baliothrips biformis, Enneothrips flavens, Frankliniella spp., Heliothrips spp., Hercinothrips femoralis, Kakothrips spp., Rhipiphorothrips cruentatus, Scirtothrips spp., Taeniothrips cardamoni, Thrips spp.

From the order of the Thysanura, for example, Lepisma saccharina.

The phytoparasitic nematodes include, for example, Anguina spp., Aphelenchoides spp., Belonoaimus spp., Bursaphelenchus spp., Ditylenchus dipsaci, Globodera spp., Heliocotylenchus spp., Heterodera spp., Longidorus spp., Meloidogyne spp., Pratylenchus spp., Radopholus similis, Rotylenchus spp., Trichodorus spp., Tylenchorhynchus spp., Tylenchulus spp., Tylenchulus semipenetrans and Xiphinema spp.

Insecticidal compositions according to the invention may, in addition to at least one of the active compounds mentioned above, also comprise other active compounds, such as further systemic insecticides, attractants, sterilants, bactericides, systemic acaricides, nematicides, fungicides, growth-regulating substances, herbicides, safeners, fertilizers or semiochemicals.

The compositions according to the invention may furthermore comprise synergists. Synergistic agents are compounds which increase the action of the active compounds, without it being necessary for the synergistic agent added to be active itself.

The compositions according to the invention may furthermore comprise inhibitors which reduce degradation of the active compound after application.

The compounds are employed in a customary manner appropriate for the formulation. The treatment according to the invention of the plants and plant parts with the compositions takes place by soil treatment, for example in the form of one of the variants mentioned at the outset.

As already mentioned above, it is possible to treat all plants according to the invention. In a preferred embodiment, wild plant species and plant cultivars, or those obtained by conventional biological breeding, such as crossing or protoplast fusion, and parts thereof, are treated. In a further preferred embodiment, transgenic plants and plant cultivars obtained by genetic engineering, if appropriate in combination with conventional methods (Genetically Modified Organisms), are treated.

Particularly preferably, plants of the plant cultivars which are in each case commercially available or in use are treated according to the invention. Plant cultivars are to be understood as meaning plants having new properties (“traits”) and which have been obtained by conventional breeding, by mutagenesis or by recombinant DNA techniques. They can be cultivars, bio- or genotypes.

Depending on the plant species or plant cultivars, their location and growth conditions (soils, climate, vegetation period, diet), the treatment according to the invention may also result in superadditive (“synergistic”) effects. Thus possible are, for example, reduced application rates and/or a widening of the activity spectrum and/or an increase of the activity of the compositions according to the invention, better plant growth, increased tolerance to high or low temperatures, increased tolerance to drought or to water or soil salt content, increased flowering, easier harvesting, accelerated maturation, higher harvest yields, higher quality and/or higher nutrient value of the harvested products, increased storability and/or processibility of the harvested products, which exceed the effects normally to be expected.

The transgenic plants or plant cultivars (i.e. those obtained by genetical engineering) which are preferably treated according to the invention include all plants which, in the genetic modification, received genetic material which imparted particularly advantageous useful properties (“traits”) to these plants. Examples of such properties are better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storability and/or processability of the harvested products. Further and particularly emphasized examples of such properties are a better defence of the plants against animal and microbial pests, such as against insects, mites, phytopathogenic fungi, bacteria and/or viruses, and also increased tolerance of the plants to certain herbicidally active compounds. Examples of transgenic plants which may be mentioned are the important crop plants, such as cereals (wheat, rice), corn, soybeans, potatoes, sugar beet, tomatoes, peas and other types of vegetable, cotton, tobacco, oilseed rape and also fruit plants (with the fruits apples, pears, citrus fruits and grapes), in particular emphasis is given to corn, soybeans, potatoes, cotton, tobacco and oilseed rape. Traits that are emphasized are in particular increased defence of the plants against insects, arachnids, nematodes and slugs and snails by toxins formed in the plants, in particular those formed in the plants by the genetic material from Bacillus thuringiensis (for example by the genes CryIA(a), CryIA(b), CryIA(c), CryIIA, CryIIIA, CrylIIB2, Cry9c Cry2Ab, Cry3Bb and CryIF and also combinations thereof) (hereinbelow referred to as “Bt plants”). Traits that are also particularly emphasized are the increased defence of the plants against fungi, bacteria and viruses by systemic acquired resistance (SAR), systemin, phytoalexins, elicitors and resistance genes and correspondingly expressed proteins and toxins. Traits that are furthermore particularly emphasized are the increased tolerance of the plants to certain herbicidally active compounds, for example imidazolinones, sulfonylureas, glyphosate or phosphinotricin (for example the “PAT” gene). The genes which impart the desired traits in question can also be present in combination with one another in the transgenic plants. Examples of “Bt plants” which may be mentioned are corn varieties, cotton varieties, soybean varieties and potato varieties which are sold under the trade names YIELD GARD® (for example corn, cotton, soybeans), KnockOut® (for example corn), StarLink® (for example corn), Bollgard® (cotton), Nucotn® (cotton) and NewLeaf® (potato). Examples of herbicide-tolerant plants which may be mentioned are corn varieties, cotton varieties and soybean varieties which are sold under the trade names Roundup Ready® (tolerance against glyphosate, for example corn, cotton, soybeans), Liberty Link® (tolerance against phosphinotricin, for example oilseed rape), IMI® (tolerance against imidazolinones) and STS® (tolerance against sulfonylurea, for example corn). Herbicide-resistant plants (plants bred in a conventional manner for herbicide tolerance) which may be mentioned include the varieties sold under the name Clearfield® (for example corn). Of course, these statements also apply to plant cultivars having these genetic traits or genetic traits still to be developed, which plants will be developed and/or marketed in the future.

The plants listed can be treated according to the invention in a particularly advantageous manner with the compositions according to the invention. The preferred ranges stated above also apply to the treatment of these plants. Particular emphasis is given to the treatment of plants with the compositions specifically mentioned in the present text.

The compositions are also suitable for controlling animal pests in the domestic field, in hygiene and in the protection of stored products, in particular insects, arachnids and mites, which are found in enclosed spaces such as, for example, dwellings, factory halls, offices, vehicle cabins and the like. They can be employed alone or in combination with other active compounds and auxiliaries in domestic insecticide products for controlling these pests. They are active against sensitive and resistant species and against all developmental stages. These pests include:

From the order of the Scorpionidea, for example, Buthus occitanus.

From the order of the Acarina, for example, Argas persicus, Argas reflexus, Bryobia spp., Dermanyssus gallinae, Glyciphagus domesticus, Ornithodorus moubat, Rhipicephalus sanguineus, Trombicula alfreddugesi, Neutrombicula autumnalis, Dermatophagoides pteronissimus, Dermatophagoides forinae.

From the order of the Araneae, for example, Aviculariidae, Araneidae.

From the order of the Opiliones, for example, Pseudoscorpiones chelifer, Pseudoscorpiones cheiridium, Opiliones phalangium.

From the order of the Isopoda, for example, Oniscus asellus, Porcellio scaber.

From the order of the Diplopoda, for example, Blaniulus guttulatus, Polydesmus spp.

From the order of the Chilopoda, for example, Geophilus spp.

From the order of the Zygentoma, for example, Ctenolepisma spp., Lepisma saccharina, Lepismodes inquilinus.

From the order of the Blattaria, for example, Blatta orientalies, Blattella germanica, Blattella asahinai, Leucophaea maderae, Panchlora spp., Parcoblatta spp., Periplaneta australasiae, Periplaneta americana, Periplaneta brunnea, Periplaneta fuliginosa, Supella longipalpa.

From the order of the Saltatoria, for example, Acheta domesticus.

From the order of the Deimaptera, for example, Forficula auricularia.

From the order of the Isoptera, for example, Kalotermes spp., Reticulitermes spp.

From the order of the Psocoptera, for example, Lepinatus spp., Liposcelis spp.

From the order of the Coleoptera, for example, Anthrenus spp., Attagenus spp., Dermestes spp., Latheticus oryzae, Necrobia spp., Ptinus spp., Rhizopertha dominica, Sitophilus granarius, Sitophilus oryzae, Sitophilus zeamais, Stegobium paniceum.

From the order of the Diptera, for example, Aedes aegypti, Aedes albopictus, Aedes taeniorhynchus, Anopheles spp., Calliphora erythrocephala, Chrysozona pluvialis, Culex quinquefasciatus, Culex pipiens, Culex tarsalis, Drosophila spp., Fannia canicularis, Musca domestica, Phlebotomus spp., Sarcophaga carnaria, Simulium spp., Stomoxys calcitrans, Tipula paludosa.

From the order of the Lepidoptera, for example, Achroia grisella, Galleria mellonella, Plodia interpunctella, Tinea cloacella, Tinea pellionella, Tineola bisselliella.

From the order of the Siphonaptera, for example, Ctenocephalides canis, Ctenocephalides felis, Pulex irritans, Tunga penetrans, Xenopsylla cheopis.

From the order of the Hymenoptera, for example, Camponotus herculeanus, Lasius fuliginosus, Lasius niger, Lasius umbratus, Monomorium pharaonis, Paravespula spp., Tetramorium caespitum.

From the order of the Anoplura, for example, Pediculus humanus capitis, Pediculus humanus corporis, Pemphigus spp., Phylloera vastatrix, Phthirus pubis.

From the order of the Heteroptera, for example, Cimex hemipterus, Cimex lectularius, Rhodinus prolixus, Triatoma infestans.

In the field of household insecticides, they are used alone or in combination with other suitable active compounds, such as phosphoric acid esters, carbamates, pyrethroids, neonicotinoids, growth regulators or active compounds from other known classes of insecticides.

The examples below illustrate the invention, without limiting it in any way.

### PREPARATION EXAMPLES

To produce a suspension concentrate, initially all liquid components are mixed with one another. In the next step, the solids are added and the mixture is stirred until a homogenous suspension is formed. The homogeneous suspension is subjected first to coarse grinding and then to fine grinding, giving a suspension in which 90% of all solid particles have a particle size of less than 10 μm. Kelzan S and water are than added with stirring at room temperature. A homogeneous suspension concentrate is obtained. Contents are stated in % by weight.

### Example 1

### Tetranychus urticae Test

### Soil Application in Rock Wool

To produce a suitable solution, the product is mixed with water and diluted with water to the desired concentration. The desired amount of additive is added to the mixtures. Eggplants (Solanum melongena) are cultivated in rock wool. At the 4-leaf stage, the product solution in question is applied to the rock wool. The stated concentration refers to the amount of active compound per plant.

At the desired point in time, the plants are infested with a mixed population of the greenhouse red spider mite (Tetranychus urticae).

After the desired period of time, the effect in % is determined. 100% means that all spider mites have been killed; 0% means that none of the spider mites have been killed.

In this test, the following mixtures provided with additive are advantageous compared to the products without additive:

TABLE 1

| | | | Time at which the | |
|---|---|---|---|---|
| | | Days between | mortality is | |
| | Concentration | application and | determined/days | |
| Active compound | (mg of ai/plant | infestation | after infestation | Mortality |
| spiromesifen (II-2) | 10 | −1 | 7 | 30 |
| | | −1 | 14 | 10 |
| | | 14 | 14 | 20 |
| +0.4% Superb HC | | −1 | 7 | 80 |
| +0.4% Plurafac LF 132 | | −1 | 14 | 90 |
| +0.4% Crovol CR 70 G | | 14 | 14 | 80 |
| spirodiclofen (II-1) | 20 | 14 | 21 | 0 |
| +0.4% Plurafac LF 132 | | 14 | 21 | 26.3 |

### Example 2

### Bemisia tabaci Test on Tomatoes

### Drench Application in Rock Wool

To produce a suitable solution, the product is mixed with water and diluted with water to the desired concentration. The desired amount of additive is added to the mixtures.

Tomato plants (Solanum lycopersicum) are cultivated in rock wool and infested with whiteflies (Bemisia tabaci). At the 2-leaf stage, the product solution in question is applied to the rock wool. The stated concentration refers to the amount of active compound per plant.

After the desired period of time, the effect in % is determined. 100% means that all the whiteflies have been killed; 0% means that none of the whiteflies have been killed.

In this test, the following mixtures provided with additive are advantageous compared to the products without additive:

TABLE 2

| | | | Time at | |
|---|---|---|---|---|
| | | Days | which the | |
| | | between | mortality is | |
| | Concentration | application | determined/ | |
| Active | (mg of | and | days | |
| compound | ai/plant | infestation | after infestation | Mortality |
| spiromesifen | 5 | −11 | 25 | 80 |
| (II-2) | | | | |
| +0.4% | | −11 | 25 | 99.5 |
| Superb HC | | | | |

### Example 3

### Bemisia tabaci Test on Cucumbers

### Drench Application in Rock Wool

To produce a suitable solution, the product is mixed with water and diluted with water to the desired concentration. The desired amount of additive is added to the mixtures.

Cucumbers (Cucumis sativa) are cultivated in rock wool and infested with whiteflies (Bemisia tabaci). At the 2-leaf stage, the product solution in question is applied to the rock wool. The stated concentration refers to the amount of active compound per plant.

After the desired period of time, the effect in % is determined. 100% means that all the whiteflies have been killed; 0% means that none of the whiteflies have been killed.

In this test, the following mixtures provided with additive are advantageous compared to the products without additive:

TABLE 3

| | | | Time at which the | |
|---|---|---|---|---|
| | Concentration | Days between | mortality is | |
| | (mg of | application and | determined/days after | |
| Active compound | ai/plant | infestation | infestation | Mortality |
| spiromesifen (II-2) | 20 | −11 | 18 | 0 |
| +0.4% Superb HC | | −11 | 18 | 95 |
| +0.4% Crovol CR 70 G | | −11 | 18 | 20 |

1. A method for controlling pests comprising applying to a plant, by watering on the ground, by droplet application on the ground or by dip application, at least one compound of formula (II) 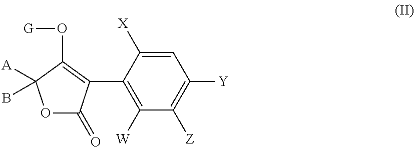
in which:
W represents hydrogen, alkyl, alkenyl, alkynyl, halogen, alkoxy, haloalkyl, haloalkoxy or cyano,
X represents halogen, alkyl, alkenyl, alkynyl, alkoxy, alkoxyalkoxy, haloalkyl, haloalkoxy or cyano,
Y represents hydrogen, halogen, alkyl, alkenyl, alkynyl, alkoxy, cyano, haloalkyl, haloalkoxy or represents in each case optionally substituted phenyl or heteroaryl,
Z represents hydrogen, halogen, alkyl, haloalkyl, cyano, alkoxy or haloalkoxy,
A represents hydrogen, in each case optionally halogen-substituted alkyl, alkenyl, alkoxyalkyl, alkylthioalkyl, saturated or unsaturated, optionally substituted cycloalkyl,
B represents hydrogen, alkyl or alkoxyalkyl, or
A and B together with the carbon atom to which they are attached represent a saturated or unsaturated, unsubstituted or substituted cycle which optionally contains at least one heteroatom,
G represents hydrogen (a) or one of the groups: 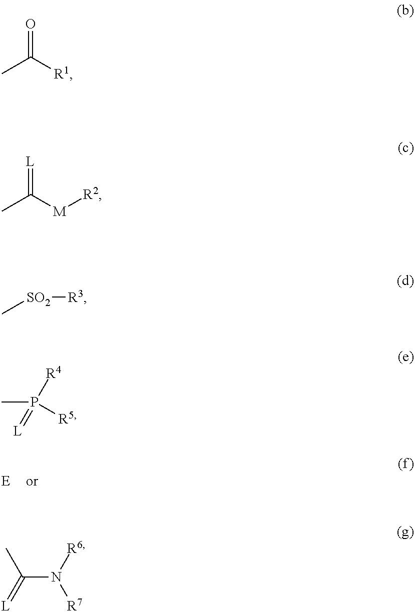
in which:
E represents a metal ion equivalent or an ammonium ion,
L represents oxygen or sulfur,
M represents oxygen or sulfur,
R¹ represents in each case optionally halogen-substituted alkyl, alkenyl, alkoxyalkyl, alkylthioalkyl, polyalkoxyalkyl or optionally halogen-, alkyl- or alkoxy-substituted cycloalkyl which is optionally interrupted by at least one heteroatom, represents in each case optionally substituted phenyl, phenylalkyl, heteroaryl, phenoxyalkyl or heteroaryloxyalkyl,
R² represents in each case optionally halogen-substituted alkyl, alkenyl, alkoxyalkyl, polyalkoxyalkyl or represents in each case optionally substituted cycloalkyl, phenyl or benzyl,
R³, R⁴ and R⁵ independently of one another represent in each case optionally halogen-substituted alkyl, alkoxy, alkylamino, dialkylamino, alkylthio, alkenylthio or cycloalkylthio or represent in each case optionally substituted phenyl, benzyl, phenoxy or phenylthio,
R⁶ and R⁷ independently of one another represent hydrogen, in each case optionally halogen-substituted alkyl, cycloalkyl, alkenyl, alkoxy, alkoxyalkyl, optionally substituted phenyl, optionally substituted benzyl, or together with the N atom to which they are bonded represent a cycle which is optionally interrupted by oxygen or sulfur.

2. The method according to claim 1, where the compound of formula (II) is spirodiclofen (II-1), or spiromesifen (II-2):

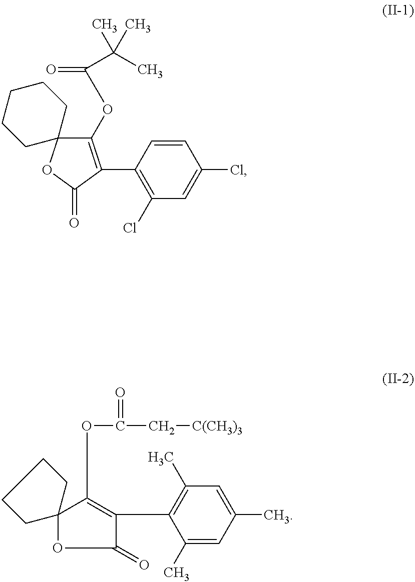

3. The method according to claim 1, where the plant to be treated is grown in an artificial growth substrate.

4. The method according to claim 3, where the artificial growth substrate is selected from the group consisting of rock wool, glass wool, quartz sand, gravel, expanded clay and vermiculite.

5. The method according to claim 1, where the plant to be treated is planted in a closed system.

6. The method according to claim 1, where the plant to be treated is selected from the group consisting of vegetables, spices, ornamental plants, shrubs, conifers and citrus plants.

7. A method for controlling pests, comprising applying to the cultivation substrate of a plant an agrochemical composition comprising at least one compound of formula (II) as defined above in claim 1 and at least one adjuvant.

8. An agrochemical composition for application in soil, comprising
at least one compound of formula (II) as defined above in claim 1,
at least one adjuvant selected from the group consisting of
dioctyl sodium sulfosuccinate,
compositions comprising dioctyl sodium sulfosuccinate and sodium benzoate,
terminally capped alkoxylated fatty alcohols and terminally capped alkoxylated straight-chain alcohols,
tributylphenol polyglycol ethers having 10 to 15 ethylene oxide units,
polyalkylene oxide-modified polymethylsiloxanes,
branched alkanol alkoxylates of formula
CH₃—(CH₂)ₜ—CH₂—O—(—CH₂—CH₂—O—)ᵤ—H
in which t represents average values from 9 to 10.5 and u represents average values from 6 to 25,
betaine,
polyalkoxylated triglycerides,
alkoxylated fatty amines,
sodium lauryl sulfate,
PEG-10 coconut alcohol and
compositions comprising corn syrup, petroleum oil and nonionic emulsifier.

9. A method for improving the crop protection activity of a compound of formula (II) as defined above in claim 1 in soil applications, comprising using at least one adjuvant.

10. The method according to claim 9, where the adjuvant is selected from the group consisting of
dioctyl sodium sulfosuccinate,
compositions comprising dioctyl sodium sulfosuccinate and sodium benzoate,
terminally capped alkoxylated fatty alcohols and terminally capped alkoxylated straight-chain alcohols,
tributylphenol polyglycol ethers having 10 to 15 ethylene oxide units,
polyalkylene oxide-modified polymethylsiloxanes,
branched alkanol alkoxylates of the formula
CH₃—(CH₂)ₜ—CH₂—O—(—CH₂—CH₂—O—)ᵤ—H,
in which t represents average values from 9 to 10.5 and u represents average values from 6 to 25,
betaine,
polyalkoxylated triglycerides,
alkoxylated fatty amines,
sodium lauryl sulfate,
PEG-10 coconut alcohol and
compositions comprising corn syrup, petroleum oil and nonionic emulsifier.

11. The method according to claim 1, where the pests are insects and/or spider mites.

12. The method according to claim 2, where the plant to be treated is grown in an artificial growth substrate.

13. The method according to claim 12, where the artificial growth substrate is selected from the group consisting of rock wool, glass wool, quartz sand, gravel, expanded clay and vermiculite.

14. The method according to claim 2, where the plant to be treated is planted in a closed system.

15. The method according to claim 3, where the plant to be treated is planted in a closed system

16. The method according to claim 4, where the plant to be treated is planted in a closed system.

17. The method according to claim 2, where the plant to be treated is selected from the group consisting of vegetables, spices, ornamental plants, shrubs, conifers and citrus plants.

18. The method according to claim 3, where the plant to be treated is selected from the group consisting of vegetables, spices, ornamental plants, shrubs, conifers and citrus plants.

19. The method according to claim 4, where the plant to be treated is selected from the group consisting of vegetables, spices, ornamental plants, shrubs, conifers and citrus plants.

20. The method according to claim 5, where the plant to be treated is selected from the group consisting of vegetables, spices, ornamental plants, shrubs, conifers and citrus plants.
